(19) United States
(12) Patent Application Publication
(10) Pub. No.: US 2024/0246604 A1
(43) Pub. Date: Jul. 25, 2024

(54) METHOD FOR OPERATING AN ELECTRICAL STEERING SYSTEM AND ELECTRICAL STEERING SYSTEM

(71) Applicant: Robert Bosch GmbH, Stuttgart (DE)

(72) Inventors: Joachim Graf, Gueglingen (DE); Sebastian Schleich, Ludwigsburg (DE); Sven Bergmann, Brackenheim (DE)

(21) Appl. No.: 18/494,977

(22) Filed: Oct. 26, 2023

(30) Foreign Application Priority Data
Jan. 24, 2023 (DE) 10 2023 200 509.3

(51) Int. Cl. B62D 6/00; B62D 5/04

(52) U.S. Cl. CPC B62D 6/002; B62D 5/0457

(57) ABSTRACT

A method for operating an electrical steering system of a vehicle. The method includes: providing the electrical steering system, which has an input device, which can be operated by an operator of the vehicle by changing an input position, and a steering device, which implements a steering movement of the vehicle by changing a wheel position angle of at least one vehicle wheel of the vehicle; executing an automated steering movement, in which an input position change and a wheel position angle change take place, and for which a starting time point, an input position change profile, and a wheel position angle change profile are specified to implement a calculated vehicle trajectory of the vehicle. The operator is notified when the automated steering movement is executed in that one or more notification measures are carried out. An electrical steering system is also described.

### CROSS REFERENCE

The present application claims the benefit under 35 U.S.C. § 119 of German Patent Application No. DE 10 2023 200 509.3 filed on Jan. 24, 2023, which is expressly incorporated herein by reference in its entirety.

### FIELD

The present invention relates to a method for operating an electrical steering system. The present invention further relates to an electrical steering system.

### BACKGROUND INFORMATION

German Patent No. DE 19912169 A1 describes an electrical steering system designed as a steer-by-wire system and having a steering control device, a steering regulator, and a feedback actuator unit. A steering request of the operator is specified via a steering wheel, and the feedback actuator unit outbuts feedback to the operator via the steering wheel.

If the electrical steering system is associated with a driver assistance function, for example a lane keeping assistant, a lane change assistant or an emergency evasion assistant, the automated steering movement of the electrical steering system can be interrupted by the operator of the vehicle, for example as soon as the operator applies at least a minimum steering wheel torque. If the steering wheel torque applied by the operator exceeds the minimum steering wheel torque, then this makes it clear that the operator wishes to terminate the automated steering movement.

The time period between the starting time point of the automated steering movement and the initiation of a reaction of the operator for applying the minimum steering wheel torque is dependent on the reaction time of the operator. This possible delay can have a disadvantageous effect on the safety targets of the automated steering movement.

### SUMMARY

According to the present invention, a method for operating an electrical steering system is provided. According to an example embodiment of the present invention, the method includes:
providing the electrical steering system, which has an input device, which can be operated by an operator of the vehicle by changing an input position, and a steering device, which implements a steering movement of the vehicle by changing a wheel position angle of at least one vehicle wheel (24) of the vehicle,
executing an automated steering movement, in which an input position change and a wheel position angle change take place and for which a starting time point, an input position change profile and a wheel position angle change profile are specified to implement a calculated vehicle trajectory of the vehicle,
wherein the operator is notified when the automated steering movement is executed in that one or more of the following notification measures are carried out:
the input position change is brought forward in time in relation to the wheel position angle change,
the input position change is at least initially elevated in relation to the specified input position change profile,
the wheel position angle change is at least initially reduced in relation to the specified wheel position angle change profile.

As a result, the operator can be notified, via the input position change brought forward in time, of an intended automated steering movement of the vehicle, which the operator can interrupt earlier if necessary or can suspend even before the wheel position angle starts to change.

According to an example embodiment of the present invention, the vehicle can be a motor-driven vehicle, preferably a motor vehicle, a commercial vehicle or a two-wheeler.

According to an example embodiment of the present invention, the electrical steering system can be a steer-by-wire system. The driving state and the roadway feedback can be transmitted back to the operator, in particular via the input device. The roadway condition, for example ruts or potholes on the roadway, can be partially or completely filtered out, damped or even amplified. A specific steering sensation can be generated thereby.

According to an example embodiment of the present invention, the electrical steering system can be used in manual, partially autonomous or autonomous driving of the vehicle. The electrical steering system can be associated with a driver assistance function, for example a lane keeping assistant, a lane change assistant or an emergency evasion assistant.

According to an example embodiment of the present invention, the input device can be a steering wheel and the input position can be a rotational position of the steering wheel. The input position change can be a change in rotational position of the steering wheel. The input device can also comprise a control stick. The input device can comprise a steering wheel actuator, which transmits a steering command of the operator, in particular electrically, wirelessly and/or optically to the steering device, without a direct force- and/or torque-transmitting connection to the steering device.

According to an example embodiment of the present invention, the steering device can comprise an actuator, in particular a rack-and-pinion actuator. The rack-and-pinion actuator can be connected to the at least one vehicle wheel. A movement of the rack-and-pinion actuator can change a wheel position angle.

The starting time point is defined as the time point after which the automated steering movement according to the related art begins in order to implement the calculated vehicle trajectory of the vehicle using the specified input position change profile and the specified wheel position angle change profile.

In a preferred embodiment of the present invention, it is advantageous if the input position change begins at a first time point, and the wheel position angle change begins at a subsequently staggered second time point. As a result, the operator can be notified of the planned wheel position angle change in advance via the input position change.

In a preferable embodiment of the present invention, it is provided for the first time point to correspond to the specified starting time point. If the automated steering movement is not interrupted by the operator, the calculated vehicle trajectory can be implemented as far as possible by a greater wheel position angle change and/or an increased wheel position angle despite the delayed initiation of the wheel position angle change.

In a specific embodiment of the present invention, it is advantageous if the first time point is before the specified starting time point. As a result, the implementation of the calculated vehicle trajectory via the wheel position angle change can be carried out as planned if the operator does not carry out a desired suspension of the automated steering movement within the time period between the first time point and the specified starting time point. The first time point can also be after the specified starting time point.

In a specific embodiment of the present invention, it is advantageous if the second time point corresponds to the specified starting time point. If the second time point and the specified starting time point are identical, the calculated vehicle trajectory can be implemented as planned by the wheel position angle change if the operator does not interrupt the automated steering movement. In contrast, the input position change brought forward in time gives the operator the time for manual intervention for suspending the automated steering movement, if required.

A preferred embodiment of the present invention in which the second time point is before or after the specified starting time point is advantageous. The selection of the second time point can depend on a driving state of the vehicle and/or on surrounding conditions of the vehicle. The second time point can also correspond to the first time point.

In a preferred embodiment of the present invention, it is advantageous if the automated steering movement is terminated at a termination time point depending on an operating value implemented by the operator during the operation of the input device. The termination time point is after the starting time point. In particular, the termination time point is at least after the first starting time point. The termination time point can be before or after the second time point. The operating value can be a manual steering wheel torque or a steering wheel angle by the operator.

In a specific embodiment of the present invention, it is advantageous if the termination takes place when the operating value exceeds a specified threshold value. The termination can take place if the steering wheel torque exceeds a specified minimum steering wheel torque and/or the steering wheel angle exceeds a specified steering wheel angle or differential angle.

In a specific embodiment of the present invention, it is advantageous if the selection of the at least one suitable notification measure for notification of the automated steering movement takes place depending on a driving state and/or surrounding conditions of the vehicle. In this way, the conditions of the vehicle and/or of the surroundings of the vehicle can be responded to situationally. Furthermore, at least one parameter of the selected notification measure can be selected depending on the driving state and/or the surrounding conditions of the vehicle. For example, the time interval between the first time point and the second time point can be selected depending on the driving state and/or the surrounding conditions of the vehicle.

According to the present invention, an electrical steering system is provided.

Further advantages and advantageous embodiments of the present invention can be found in the description of the figures and in the figures.

### BRIEF DESCRIPTION OF THE DRAWINGS

The present invention is described in detail below with reference to the figures.

FIG. 1 shows an electrical steering system and a method for operating an electrical steering system in a specific embodiment of the present invention.

FIG. 2 shows a line graph during execution of an automated steering movement according to the related art.

FIG. 3 shows a line graph during execution of a method for operating an electrical steering system in a further specific embodiment of the present invention.

FIG. 4 shows a line graph during execution of a method for operating an electrical steering system in a further specific embodiment of the present invention.

### DETAILED DESCRIPTION OF EXAMPLE EMBODIMENTS

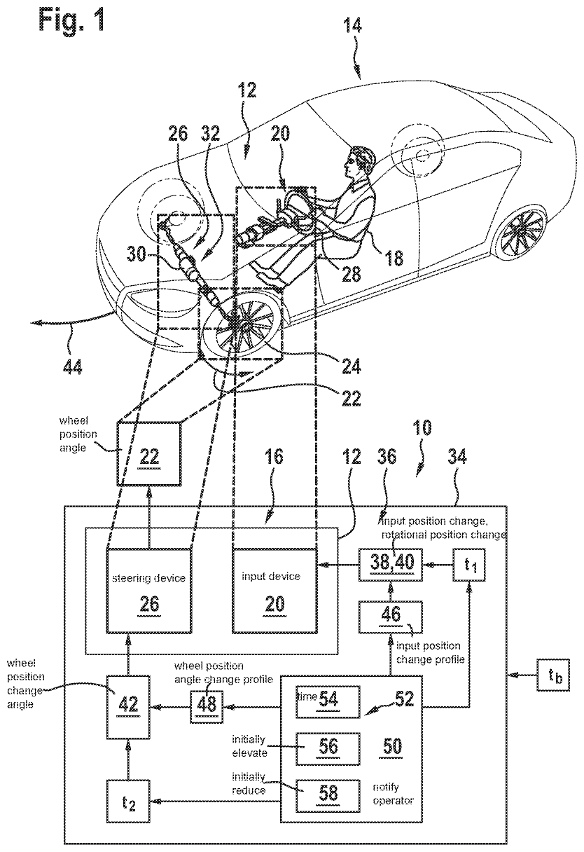

FIG. 1 shows an electrical steering system and a method for operating an electrical steering system in a specific embodiment of the present invention. The method 10 for operating an electrical steering system 12 of a vehicle 14 is carried out during operation of the vehicle 14. First, the electrical steering system 12 is provided 16, which has an input device 20, which can be operated by an operator 18 of the vehicle 14 by changing an input position, and a steering device 26, which implements a steering movement of the vehicle 14 by changing a wheel position angle 22 of at least one vehicle wheel 24 of the vehicle 14. The input device 20 comprises a steering wheel 28, which can be actuated, i.e., rotated, by the operator 18. The steering device 26 comprises in particular a rack-and-pinion actuator 30, which is connected to the vehicle wheels 24 of the front axle 32 of the vehicle 14 and sets a wheel position angle 22 of the vehicle wheels 24.

The electrical steering system 12 is configured to execute an automated steering movement 34 of the vehicle 14. The automated steering movement 34 can be executed in a lane keeping task, a lane change task, or an emergency evasion task, and can be interrupted manually by the operator 18 of the vehicle 14.

During execution 36 of the automated steering movement 34, an input position change 38 of the input device 20, here a rotational position change 40 of the steering wheel 28, and a wheel position angle change 42 of the vehicle wheels 24 of the front axle 32 take place by means of the steering device 26, here the rack-and-pinion actuator 30.

A starting time point to, an input position change profile 46 and a wheel position angle change profile 48 are specified for the automated steering movement 34 to implement a calculated vehicle trajectory 44 of the vehicle 14. With the starting time point t_{b}, the automated steering movement 34 is initiated and implements the specified input position change profile 46 and the specified wheel position angle change profile 48 so that the calculated vehicle trajectory 44 can be executed.

With the execution 36 of the automated steering movement 34, the operator 18 is notified 50 of the initiation of the automated steering movement 34 in that one or more of the following notification measures 52 perceivable by the operator 18 are carried out. The input position change 38 is brought forward in time 54 in relation to the wheel position angle change 42, the input position change 38 is at least initially elevated 56 in relation to the specified input position change profile 46, the wheel position angle change 42 is at least initially reduced 58 in relation to the specified wheel position angle change profile 48. The notification measures 52 can influence the first time point t₁ from which the input position change 38 begins, the second time point t₂ from which the wheel position angle change 42 begins, the input position change profile 46 and/or the wheel position angle change profile 48.

FIG. 2 shows a line graph during execution of an automated steering movement according to the related art. The line graph shows a specified input position change profile 46 as a time profile of the input position 47, which is a rotational position of the steering wheel, and a specified wheel position angle change profile 48 as a time profile of the wheel position angle 22 of at least one vehicle wheel of the vehicle. Furthermore, a possible steering wheel torque profile is also shown as a time profile of a steering wheel torque 59 applied manually by the operator in response to the fed back steering torque.

The automated steering movement 34 is initiated to implement a calculated vehicle trajectory of the vehicle at a specified starting time point t_{b} by applying the specified input position change profile 46 and the specified wheel position angle change profile 48. At the same time, the input position 47 and the wheel position angle 22 are changed. In this case, the automated steering movement 34 by application of a steering wheel torque 59 is indicated as undesired by the operator. The steering wheel torque 59 counteracts the input position change 38. If the steering wheel torque 59 exceeds a specified threshold value G, in particular in amount, such as here a specified minimum steering wheel torque, then the automated steering movement 34 is terminated, here at the termination time point tᵢ.

The opposing steering movement of the vehicle that is actually desired by the operator then manifests on the positive steering wheel torque 59 until the manual steering movement is finally ended.

The time period 60 between the starting time point t_{b} and the termination time point tᵢ depends on the reaction time 62 of the operator and can impair the driving behavior and the driving safety of the vehicle.

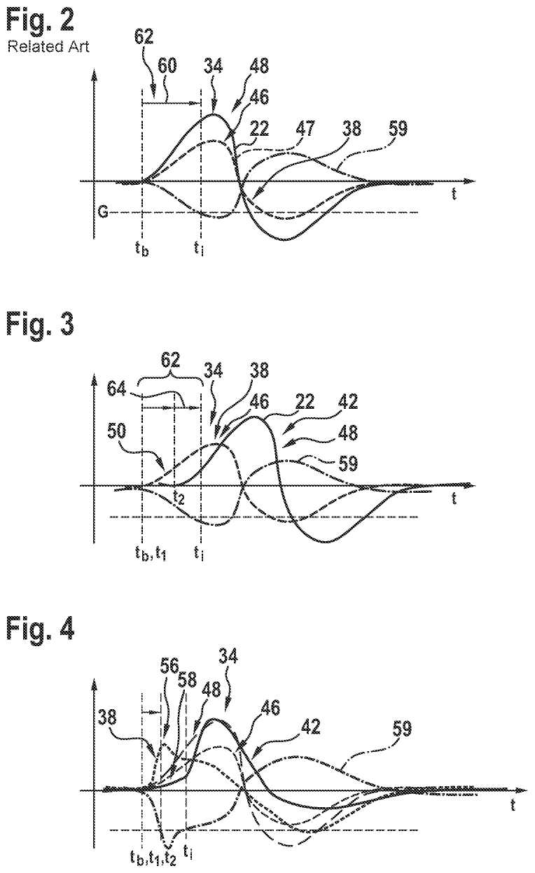

FIG. 3 shows a line graph during execution of a method for operating an electrical steering system in a further specific embodiment of the present invention. As in FIG. 3, the line graph shows the input position change profile 46 over time, the wheel position angle change profile 48 over time, and the time profile of the steering wheel torque 59. The input position change 38 begins at the first time point t₁, and the wheel position angle change 42 begins at the subsequently staggered second time point t₂. The first time point t₁ corresponds to the specified starting time point t_{b}.

At the termination time point tᵢ, the wheel position angle 22 is even smaller than in FIG. 2. As a result, when the automated steering movement 34 is terminated at the time point tᵢ, the vehicle can be brought to the direction of travel desired by the operator more quickly and safely. The reaction time 62 required by the operator is reduced to a shorter action time 64, during which the wheel position angle change 42 already took place up to the termination time point tᵢ.

If the operator does not interrupt the automated steering movement 34, the calculated vehicle trajectory can be implemented as closely as possible to the specification, despite the delayed initiation of the wheel position angle change 42 at the second time point t₂, by a greater wheel position angle change 42 and/or an increased maximum wheel position angle 22.

Alternatively, the second time point t₂ can correspond to the starting time point t_{b}, and the first time point t₁ can be before the specified starting time point t_{b}. The notification 50 of the automated steering movement 34 can thus take place even before the actually specified starting time point to in order to keep the reaction time 62 of the operator more favorable and to reduce the action time 64.

FIG. 4 shows a line graph during execution of a method for operating an electrical steering system in a further specific embodiment of the present invention. The input position change 38 begins, for example, at the first time point t₁, which also corresponds to the specified starting time point t_{b}. The wheel position angle change 42 also begins with the second time point t₂ at the starting time point t_{b}. The specified input position change profile 46 and the specified wheel position angle change profile 48 according to the related art that could be applied to implement the calculated vehicle trajectory are also shown for comparison.

However, the input position change 38 and the wheel position angle change 42 are carried out differently in that the input position change 38 is initially elevated 56 in relation to the specified input position change profile 46, and at the same time the wheel position angle change 42 is initially reduced 58 in relation to the specified wheel position angle change profile 48. If the operator wants to terminate the automated steering movement 34 by applying the steering wheel torque 59, in this case at the termination time point tᵢ, the dynamic and kinematic effects on the vehicle with a terminated automated steering movement 34 are lower.

What is claimed is:

1. A method for operating an electrical steering system of a vehicle, comprising the following steps:
providing the electrical steering system, which has an input device which can be operated by an operator of the vehicle by changing an input position, and a steering device which implements a steering movement of the vehicle by changing a wheel position angle of at least one vehicle wheel of the vehicle;
executing an automated steering movement, in which an input position change and a wheel position angle change take place and for which a starting time point, an input position change profile, and a wheel position angle change profile are specified to implement a calculated vehicle trajectory of the vehicle; and
notifying the operator when the automated steering movement is executed in that one or more of the following notification measures are carried out:
the input position change is brought forward in time in relation to the wheel position angle change,
the input position change is at least initially elevated in relation to the specified input position change profile,
the wheel position angle change is at least initially reduced in relation to the specified wheel position angle change profile.

2. The method for operating the electrical steering system according to claim 1, wherein the input position change begins at a first time point, and the wheel position angle change begins at a subsequently staggered second time point.

3. The method for operating the electrical steering system according to claim 2, wherein the first time point corresponds to the specified starting time point.

4. The method for operating the electrical steering system according to claim 2, wherein the first time point is before the specified starting time point.

5. The method for operating the electrical steering system according to claim 4, wherein the second time point corresponds to the specified starting time point.

6. The method for operating the electrical steering system according to claim 4, wherein the second time point is before or after the specified starting time point.

7. The method for operating the electrical steering system according to claim 1, wherein the automated steering movement is terminated at a termination time point depending on an operating value implemented by the operator during operation of the input device.

8. The method for operating then electrical steering system according to claim 7, wherein the termination takes place when the operating value exceeds a specified threshold value.

9. The method for operating the electrical steering system according to claim 1, wherein a selection of the at least one notification measure for notification of the automated steering movement is dependent on a driving state and/or surrounding conditions of the vehicle.

10. An electrical steering system, comprising:
an input device which can be operated by an operator of the vehicle by changing an input position; and
a steering device which implements a steering movement of the vehicle by changing a wheel position angle of at least one vehicle wheel of the vehicle;
wherein the electrical steering system is configured to:
execute an automated steering movement, in which an input position change and a wheel position angle change take place and for which a starting time point, an input position change profile, and a wheel position angle change profile are specified to implement a calculated vehicle trajectory of the vehicle, and
notify the operator when the automated steering movement is executed in that one or more of the following notification measures are carried out:
the input position change is brought forward in time in relation to the wheel position angle change,
the input position change is at least initially elevated in relation to the specified input position change profile,
the wheel position angle change is at least initially reduced in relation to the specified wheel position angle change profile.
